(19) United States
(12) Patent Application Publication
(10) Pub. No.: US 2025/0390763 A1
(43) Pub. Date: Dec. 25, 2025

(54) SYSTEM AND METHOD FOR ENHANCED DATA PROCESSING AND ARTIFICIAL INTELLIGENCE (AI) QUERY RESOLUTION WITH PERSONALIZED CONTENT DELIVERY

(71) Applicant: Riccardo Vieri, Firenza (IT)

(72) Inventor: Riccardo Vieri, Firenza (IT)

(21) Appl. No.: 18/751,453

(22) Filed: Jun. 24, 2024

(51) Int. Cl. G06N 5/02

(52) U.S. Cl. CPC G06N 5/02

(57) ABSTRACT

The present invention pertains to the field of Artificial Intelligence (AI) and data processing, specifically aimed at enhancing data processing, personalized content delivery, and security. Existing AI and data processing systems often suffer from inefficient data processing, signal degradation, limited personalization in content delivery, and insufficient security measures, leading to suboptimal user experiences, potential security vulnerabilities, and decreased efficiency in data processing.

The proposed system comprises an AI-driven computing device equipped with a sensor-augmented input apparatus that receives multi-dimensional user inputs. Advanced data fusion algorithms and machine learning techniques are employed for signal optimization. An intelligent data processing hub enhances power management and processing efficiency. An affective computing module utilizes sentiment analysis, anomaly detection, and predictive modeling for security.

Furthermore, the system features a contextual inference engine and predictive intent recognition system that analyze user behaviors, contextual cues, and intended outcomes. A Dynamic Content Generation System generates customized content tailored to individual users. An adaptive content delivery interface ensures effective presentation of the personalized content.

The system enhances power management, processing efficiency, and security measures, thereby providing an optimized user experience and addressing the limitations of existing AI and data processing systems.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

This invention relates generally to The present invention relates to a data processing and artificial intelligence (AI) system configured to optimize the processing, organization, and dissemination of tailored information through AI query resolution. The AI system comprises a sensor-equipped input device capable of obtaining multi-dimensional data inputs via multiple channels while minimizing signal degradation through sophisticated data fusion algorithms and machine learning (ML) techniques. The invention features an intelligent data processing hub, interconnected with the input apparatus, that utilizes advanced power management strategies and scalable design principles to enable efficient data processing, refinement, and optimization of user data profiles. This results in enhanced signal integrity, reduced heat generation, and improved overall performance and reliability, making it a significant advancement in the field of AI query processing systems. The AI system includes a dynamic content generation system, communicatively connected to the affective computing module, contextual inference engine, and predictive intent recognition system. This system tailors information by generating dynamic content based on user data profiles and preferences. The adaptive delivery interface, communicatively coupled to the personalized generation system facilitates the delivery of tailored information to the end-user.

### 2. Description of the Related Art

In the current technological landscape, the prevalent methods of content generation are predominantly driven by predefined settings such as keyword matching, user behavior analysis across multiple websites, and browser language preferences. These conventional approaches often result in the production of generic information that frequently fails to meet individualized expectations.

These data generation systems are characterized by their intrusive nature, necessitating continuous tracking and monitoring of user activities. Moreover, such data systems are typically controlled by a limited number of monopolistic organizations, restricting the diversity and personalization of the available information.

In the existing state of the art, information addition is primarily achieved through pervasive means such as advertisements and promotional campaigns. Users of search engines or websites view content based on predefined algorithms and settings that rely on keyword matching, user behavior tracking across websites, browser language preferences, and so forth, resulting in mostly generic data generation. The systems in operation tend to be intrusive and monopolized by a few dominant companies, leading to an experience that is not deeply aligned with individual user expectations.

Traditional systems often handle massive volumes of data due to the need to track and analyze user behaviors across multiple websites. This requires substantial processing power and storage capacity. As the amount of data increases, the hardware may struggle to scale efficiently, leading to increased latency, slower processing times, and higher costs for hardware expansion.

Continuous tracking and monitoring of user activities demand significant data storage capabilities. This involves not only the raw data but also the storage of processed data for quick retrieval. Over time, the storage systems can become overwhelmed, impacting data retrieval speeds and efficiency. This can degrade system performance and the overall experience.

The constant data processing and server operations maintenance to analyze user behavior is energy-intensive. High energy consumption leads to increased operational costs and contributes to larger environmental impacts, which is increasingly a concern for modern businesses.

Continuous operation of servers and data centers, especially those utilizing complex algorithms for data processing, generates significant amounts of heat. Excessive heat can lead to hardware malfunctions and reduced component lifespan, necessitating more frequent maintenance and replacement, which in turn raises operational costs.

Systems that continuously track and store data are prime targets for cyber-attacks. The invasive nature of data collection also raises privacy concerns. Any security breach not only risks compromising data but can also lead to severe legal and reputational consequences for the service provider.

The dominance of a few companies in data delivery can force reliance on proprietary hardware and software solutions. This dependency limits innovation and flexibility in system design, leading to higher costs and reduced control over the information generation and distribution process.

Users increasingly demand personalized data that aligns with their individual interests and preferences. Innovative solutions that prioritize user-centric approaches will gain a competitive edge.

Corporate environments are finding that the increasing volume of data requires efficient processing and storage solutions.

Companies must prioritize energy efficiency and sustainability to reduce operational costs and environmental impact, as well as data security and privacy to maintain customer trust.

Traditional data processing methods often rely on manual analysis and can be time-consuming, labor-intensive, and prone to human error. There is a need for a more efficient and accurate data processing system.

The use of AI in data processing provides several benefits, including increased speed, accuracy, and efficiency. The AI module can process large volumes of data in a fraction of the time it would take a human to analyze the same data. Additionally, the AI module is less prone to errors than human analysts, resulting in more accurate data processing. AI holds the potential to transform data generation by focusing on personalized experiences that closely align with the user's emotional state, current context, and intended actions.

In light of these challenges, the present invention introduces a system for dynamically generating personalized content during AI query data processing and improving overall data processing. This system aims to revolutionize the way AI interacts with users by providing tailored information that aligns with the user's emotional state, context, and intended actions.

The present invention offers several hardware advantages and addresses existing limitations. The integration of AI and ML techniques facilitates efficient power consumption and management, resulting in reduced heat generation and increased overall longevity and reliability of the circuits. The modular design allows for easy integration and upgrading of various circuits, ensuring the AI-driven system remains current with ML advancements.

The system's sophisticated data fusion algorithms and ML techniques minimize signal degradation, maintaining high-fidelity signal transmission and reception, thereby enhancing overall performance. The AI-driven data processing approach enables faster and more efficient computation, reducing latency and improving performance.

The system's advanced data assimilation and fusion capabilities optimize memory usage, reducing the memory footprint, and increasing data storage efficiency. The sensor-augmented input apparatus, combined with advanced AI-driven data processing, ensures accurate and reliable sensor data collection and analysis.

The system's AI-driven security features, such as anomaly detection and predictive modeling, provide robust protection against potential threats, maintaining system integrity and safeguarding sensitive data. The system's architecture enables infrastructure to adapt and scale with increasing data volumes and user demands, ensuring the system remains efficient and responsive under varying workloads.

The intelligent data assimilation hub, linked to the sensor-augmented input apparatus, employs enhanced power management and scalable design principles to efficiently process and refine user data profiles, minimizing heat generation and ensuring improved signal integrity.

The dynamic personalized content generation system and adaptive delivery interface guarantees swift, dependable, and tailored information delivery to users, contributing to an enhanced experience and increased engagement.

### BRIEF SUMMARY OF THE INVENTION

The present invention relates to a System for Enhanced Data Processing and Artificial Intelligence Query Resolution with Dynamic Content Delivery. The AI system includes at least an Ai driven computing device, and comprises a sensor-augmented input apparatus that receives multi-dimensional data inputs, with advanced data fusion algorithms and machine learning techniques for reducing signal degradation. An intelligent data processing hub, linked to the sensor-augmented input apparatus, employs enhanced power management and scalable design principles for efficient processing and refining data profiles, thereby ensuring improved signal integrity and minimized heat generation.

An affective computing module, integrally connected to the intelligent data assimilation hub, utilizes deep learning frameworks for sentiment analysis, multi-faceted emotional state determination, anomaly detection, and predictive modeling for enhanced security. A contextual inference engine, coupled with the intelligent data assimilation hub, applies machine learning-based context inference algorithms for analyzing behaviors and refining classifications of contextual scenarios, with adaptive updates for reflecting changes in behavior patterns and preferences.

A predictive intent recognition system, interfacing with the contextual inference engine and the affective computing module, employs iterative neural network models and reinforcement learning techniques for intricate analysis of interactions and predicting intended outcomes, thereby enhancing processing efficiency and reducing latency.

A dynamic personalized data generation system generates and customizes information aligned with identified emotional states, contextual cues, and predicted intents.

An adaptive delivery interface ensures effective presentation and delivery of the generated personalized information, optimized for fast, reliable, and personalized distribution.

The AI system further comprises an advanced feedback mechanism for real-time interaction adjustments and continuous improvement of sentiment analysis and emotional state determination.

Additionally, the sensor-augmented input apparatus comprises a plurality of sensors for receiving multi-dimensional inputs specifically including, but not limited to: textual data, vocal commands, gestural interactions, biometric parameters, ambient light conditions, sound waves, geolocation information, brain-computer interfaces, haptic interfaces, quantum sensors, synthetic biology sensors, adapted to detect biochemical changes in an environment, a molecular communication interface, facilitating interaction with nano-scale devices, as well as olfactory and gustatory interfaces.

Additionally, the affective computing module utilizes neuromorphic chips that mimic neural network architectures, leading to real-time sentiment analysis and emotional state determination with reduced computational load and enhanced contextual accuracy.

The system further comprises an environmental factors analyzer integrated with the contextual inference engine, the analyzer being capable of capturing and interpreting ambient light intensity, sound level fluctuations, and geolocation data, thereby improving the precision and contextual relevance of personalized information.

The system further comprises a cross-platform synchronization module that utilizes blockchain technology to seamlessly integrate and synchronize data profiles and personalized information across various devices, including smartphones, tablets, wearables, The intelligent data processing hub comprises an AI-powered encryption module that ensures end-to-end data security, incorporating blockchain technology.

Additionally, the system further comprises, a self-diagnosing and self-repairing module with AI-driven predictive maintenance, capable of diagnosing potential failures, suggesting solutions, and autonomously performing minor repairs using self-healing materials.

Additionally, the sensor-augmented input apparatus incorporates photovoltaic solar cells with advanced nanomaterial coatings, enabling energy harvesting to power the apparatus and supporting sustainable operation even in low-light environments.

Additionally the intelligent data processing hub uses at least one of these materials: Graphene as a conductive material for efficient heat dissipation and improved electrical conductivity; Carbon Nanotubes as a reinforcing material for increased mechanical strength and thermal conductivity; Topological Insulators as a material for reducing heat generation and improving energy efficiency; Metamaterials as a material for manipulating electromagnetic waves and improving communication efficiency; Indium Phosphide (InP) as a material for high-speed electronic devices and optoelectronic applications; Gallium Nitride (GaN) as a material for high-power and high-frequency electronic devices; Stanene as a material for low-power electronics and spintronics; Bismuth Ferrite (BiFeO3) as a material for multiferroic applications and energy harvesting; Nanostructured Silicon (NSi) as a material for high-performance sensors and energy storage; Graphene Oxide (GO) as a material for energy storage and biocompatible applications.

Additionally, the intelligent data processing hub integrates quantum dot solar cells with tandem junction architectures, capable of converting a wider spectrum of light into electrical energy, thereby significantly enhancing power efficiency and extending device longevity.

Additionally, the intelligent data processing hub is crafted with self-healing nanomaterials and equipped with adaptive thermal management systems that autonomously repair micro-damages and regulate temperature dynamically, thus vastly increasing the lifespan and reliability of the hub under diverse operational conditions.

Additionally, the intelligent data processing hub employs graphene-based transistors for data processing, offering unprecedented speed and efficiency while dramatically reducing power consumption, thereby supporting a broader range of applications including mobile and wearable technology.

Additionally, the intelligent data processing hub comprises a quantum communication interface, including an entangled photon system for secure and instantaneous data exchange and a decryption module for safeguarded transmission, facilitating encrypted, high-speed data transfer; an high-speed data processing module utilizing photonic computing technology, consisting of a photon-based arithmetic logic unit (ALU), a photonic memory, and an interface for communication with the intelligent data processing hub.

Additionally, the adaptive delivery interface is integrated with various systems, including, but not limited to: smartphones, smart watches, desktop PCs, laptops, tablets, smart TV systems, IoT-enabled water devices, smart home assistants, fitness trackers, and smart appliances, enabling personalized recommendations and interactive experiences based on multi-dimensional data input analytics, including viewing history, preferences, and real-time engagement metrics.

Additionally, the sensor-augmented input apparatus integrates quantum sensors, enabling ultra-sensitive detection and processing of quantum-level inputs, thereby amplifying accuracy and precision in interaction capture and interpretation.

The system further comprises a holographic content generation subsystem, which utilizes augmented and virtual reality technologies to provide immersive, multi-sensory personalized experiences tailored to emotional and contextual data.

Additionally, the intelligent data assimilation hub further comprises a robust multilingual data preprocessing unit, outfitted with automatic language detection and translation capabilities, allowing for uninterrupted multilingual data processing and increasing global engagement through customized information tailored to the user's preferred linguistic preference.

Additionally, the sensor-augmented input apparatus utilizes flexible electronic skins (e-skins) capable of detecting a wide range of gestures and biometric inputs through stretchable, touch-sensitive materials, enhancing interaction in virtual and augmented reality environments.

Additionally, the intelligent data processing hub includes a quantum communication interface, enabling secure and instantaneous data exchange based on quantum entanglement principles, dramatically enhancing data security and processing speed.

Additionally, the system further comprises a neural interface module within the sensor-augmented input apparatus, enabling direct brain-to-device communication through non-invasive brainwave analysis, facilitating an unprecedented level of interaction and accessibility.

Additionally, the system further comprises quantum sensors, as well as olfactory and gustatory interfaces.

Additionally, the system comprises an adaptive multi-modal feedback system, which uses augmented reality (AR) and haptic feedback to provide users with immersive and tactile interactions, enhancing learning and entertainment experiences. Additionally, the dynamic personalized data fabrication system employs generative adversarial networks (GANs) to create highly realistic and customized virtual environments and avatars, offering unparalleled personalization in gaming, education, and social networking.

Additionally, the intelligent data processing hub includes an AI-driven space-time compression algorithm for data storage, significantly increasing the data storage capacity without physical expansion of the storage medium.

The system further comprises an intelligent data processing hub that is responsible for processing and refining data. Furthermore, the apparatus features an affective computing unit that analyzes sentiment and emotional state.

The present invention contemplates an apparatus for optimized information processing and delivery. The apparatus comprises a sensor-augmented input apparatus designed to receive multi-dimensional inputs.

Additionally, the apparatus includes a contextual inference engine for categorizing behaviors, as well as a predictive intent recognition system for analyzing interaction.

The apparatus also features a dynamic data fabrication system that creates and customizes information according to preferences.

Finally, the apparatus includes an adaptive delivery interface that is responsible for presenting and distributing personalized information.

The present invention contemplates a processor. The system also features a diverse array of innovative components, including but not limited to quantum dot photodetectors, neuromorphic chips, environmental factors analyzers, cross-platform synchronization modules, photovoltaic solar cells, quantum sensors, holographic content generation subsystems, and robust multilingual data preprocessing units, to name a few. These cutting-edge technologies converge to propel the AI system's capabilities to unprecedented heights, maximizing its performance, efficiency, and versatility in multiple domains, including but not limited to security, contextual accuracy, power efficiency, and global engagement, thereby unlocking unparalleled possibilities for a wide range of applications and use cases.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a Diagram of the overall system architecture.

FIG. 2 illustrates a Flowchart of the data processing pipeline.

FIG. 3 illustrates a Diagram of the affective computing module and how the unit may utilize sub-components such as neuromorphic chips or quantum dot photodetectors to enhance its functionality.

FIG. 4 illustrates the intelligent data assimilating hub, linked to the sensor-augmented input apparatus, and how the hub utilizing enhanced power management and scalable design can ensure improved signal integrity and minimized heat generation.

FIG. 5 illustrates a Diagram of the Dynamic Content Generation System.

FIG. 6 illustrates an example of the adaptive content delivery interface.

FIG. 7 illustrates a Flowchart of the A method for enhanced data processing and artificial intelligence query resolution with personalized content delivery.

The various embodiments of the present invention will hereinafter be described in conjunction with the appended drawings.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

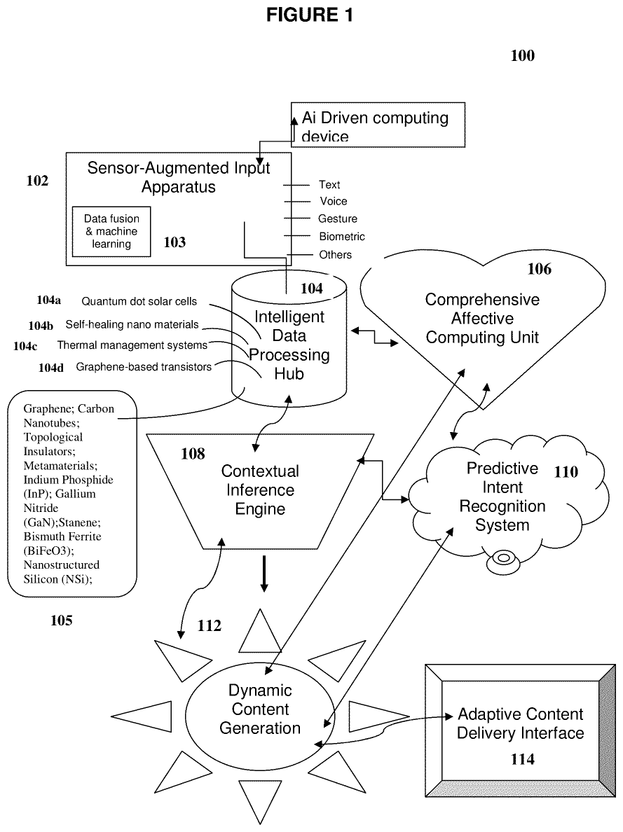

FIG. 1 illustrates the system consisting in several interconnected components, each designed to perform specific functions in the data processing and personalized content delivery pipeline.

The System comprises at least one AI-driven edge computing device (101).

The Sensor-Augmented Input Apparatus (102), receives multi-dimensional user inputs through various channels, such as text, vocal commands, gestural interactions, and biometric data. In particular embodiments the apparatus employs advanced data fusion algorithms and machine learning techniques (103) to minimize signal degradation and ensure high-quality input data.

The Sensor-Augmented Input Apparatus (102) is connected to the Intelligent Data Processing Hub (104), which leverages enhanced power management and scalable design principles to efficiently process and refine user data profiles. The hub ensures improved signal integrity and minimizes heat generation during data processing.

In particular embodiments the intelligent data assimilation hub (104) may integrate quantum dot solar cells (102a) with tandem junction architectures, converting a wider spectrum of light into electrical energy, thereby significantly enhancing power efficiency and extending device longevity.

In particular embodiments the intelligent data assimilation hub (104) may be crafted with self-healing nanomaterials (102b) and equipped with adaptive thermal management systems (102c), increasing the lifespan and reliability under diverse operational conditions.

In particular embodiments the intelligent data assimilation hub (104) may employ graphene-based transistors (104e) for data processing, offering unprecedented speed and efficiency while dramatically reducing power consumption, thereby supporting a broader range of applications including mobile and wearable technology.

In other embodiments the intelligent data processing hub comprises one or of the following high-performance materials for specific functions (105): Graphene as a conductive material for efficient heat dissipation and improved electrical conductivity; Carbon Nanotubes as a reinforcing material for increased mechanical strength and thermal conductivity; Topological Insulators as a material for reducing heat generation and improving energy efficiency; Metamaterials as a material for manipulating electromagnetic waves and improving communication efficiency; Indium Phosphide (InP) as a material for high-speed electronic devices and optoelectronic applications; Gallium Nitride (GaN) as a material for high-power and high-frequency electronic devices; Stanene as a material for low-power electronics and spintronics; Bismuth Ferrite (BiFeO3) as a material for multiferroic applications and energy harvesting; Nanostructured Silicon (NSi) as a material for high-performance sensors and energy storage; Graphene Oxide (GO) as a material for energy storage and biocompatible applications.

Adjacent to the Intelligent Data Processing Hub (104) is the Affective computing module (106), which utilizes deep learning frameworks to execute sentiment analysis and multi-faceted emotional state determination. This unit further enhances security through the use of anomaly detection and predictive modeling techniques.

The Contextual Inference Engine (108) is linked to the Intelligent Data Processing Hub (104) and employs machine learning-based context inference algorithms to analyze user behaviors. The engine systematically categorizes user inputs into refined classifications of contextual scenarios, with adaptive updates that reflect changes in user behavior patterns and preferences.

The Predictive Intent Recognition System (110) interfaces with the Contextual Inference Engine (108) and the Affective computing module (106). This system uses iterative neural network models and reinforcement learning techniques to intricately analyze user interactions and predict intended outcomes, thereby enhancing processing efficiency and reducing latency.

The Dynamic Content Generation System (112) is interconnected with the Affective computing module (106), Contextual Inference Engine (108), and Predictive Intent Recognition System (110). This fabrication system is responsible for generating and customizing content aligned with identified emotional states, contextual cues, and predicted user intents. The system further enhances user experience through scalable and flexible infrastructure and efficient data management.

Finally, the Adaptive Content Delivery Interface (114) is connected to the Dynamic Content Generation System (112) and is accountable for the effective presentation and delivery of the generated personalized content. The interface is optimized for fast, reliable, and personalized content distribution to users.

The adaptive content delivery interface may be integrated with various systems, enabling personalized content recommendations and interactive experiences based on multi-dimensional user input analytics.

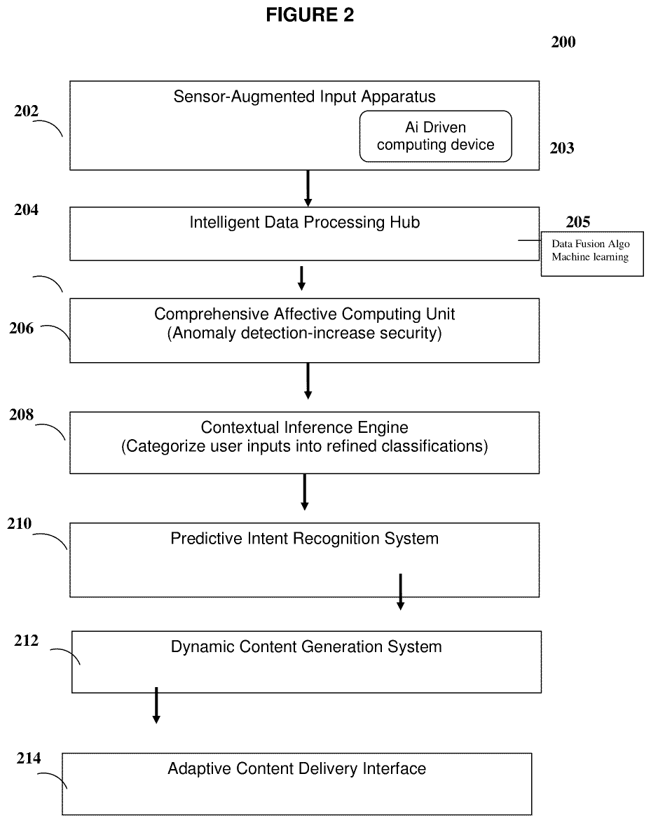

FIG. 2 illustrates a Flowchart of the data processing pipeline. The flowchart commences with the Sensor-Augmented Input Apparatus (202), equipped with Ai driven computing device (203), which receives multi-dimensional user inputs through text, vocal commands, gestural interactions, and biometric data. The user inputs are then transmitted to the Intelligent Data Processing Hub (204), where they undergo advanced data fusion algorithms and machine learning techniques to reduce signal degradation and enhance signal integrity (205).

Following the Intelligent Data Assimilating Hub (204), the data is transmitted to the Affective computing module (206), which utilizes deep learning frameworks to execute sentiment analysis and multi-faceted emotional state determination. The unit further employs anomaly detection and predictive modeling techniques to enhance security.

The data is then transmitted to the Contextual Inference Engine (208), where machine learning-based context inference algorithms are applied to analyze user behaviors and systematically categorize user inputs into refined classifications of contextual scenarios. The engine features adaptive updates that reflect changes in user behavior patterns and preferences.

The Predictive Intent Recognition System (210) interfaces with the Contextual Inference Engine (208) and the Affective computing module (206), employing iterative neural network models and reinforcement learning techniques to analyze user interactions and predict intended outcomes. This system enhances processing efficiency and reduces latency.

The Dynamic Content Generation System (212) generates and customizes content aligned with identified emotional states, contextual cues, and predicted user intents. The system further adapts to enhance user experience through scalable and flexible infrastructure and efficient data management.

Finally, the Adaptive Content Delivery Interface (214) is connected to the Dynamic Content Generation System (212), responsible for the effective presentation and delivery of the generated personalized content. The interface is optimized for fast, reliable, and personalized content distribution to users.

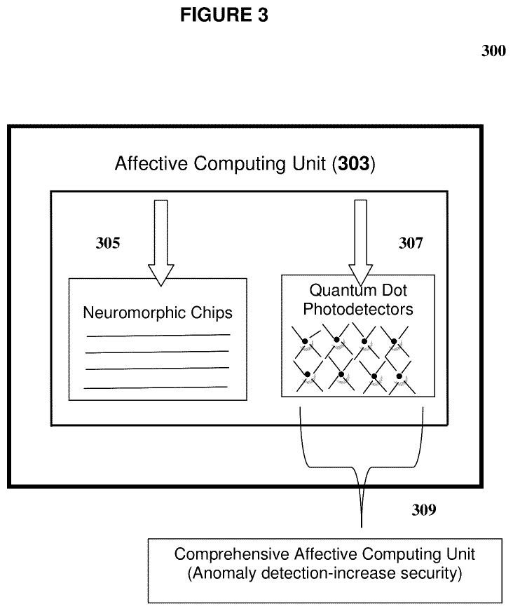

FIG. 3 illustrates a Diagram of the Affective computing module (303), including sub-components such as neuromorphic chips (305) and quantum dot photodetectors (307).

Neuromorphic chips (305), modeled after the human brain, allow for efficient processing and analysis of complex data, while quantum dot photodetectors (307) enhance the affective computing module's (309) functionality by detecting and converting light into electrical signals, thereby improving sentiment analysis and emotional state determination.

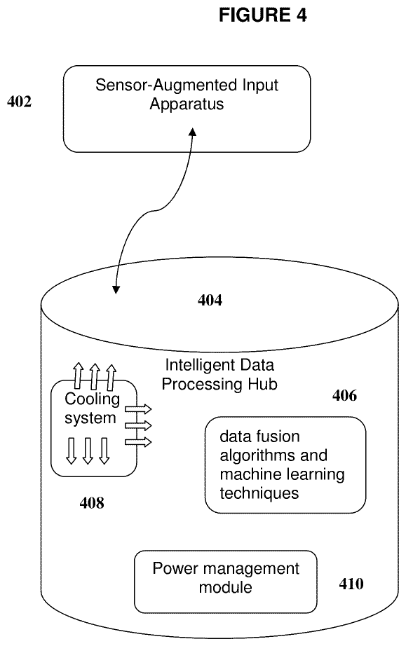

FIG. 4 focuses on the Intelligent Data Assimilating Hub (404), which is linked to the Sensor-Augmented Input Apparatus (402). The Hub (404) is designed with enhanced power management and scalable principles, allowing it to efficiently process and refine user data profiles. This results in improved signal integrity and minimized heat generation.

The Data Assimilation Hub (404) receives multi-dimensional user inputs from the Sensor-Augmented Input Apparatus (402) To reduce signal degradation, the Hub (404) employs advanced data fusion algorithms and machine learning techniques (406).

The Data Assimilation Hub (404) is designed to handle the large volume of data received from the Sensor-Augmented Input Apparatus (402), ensuring that the processing of this data is efficient and reliable. The Hub (404) is also equipped with a cooling system (408) that minimizes heat generation during data processing. This cooling system is strategically placed within the Hub (404) to ensure even heat distribution and dissipation.

The Data Assimilation Hub (404) also includes a power management module (410) that regulates the flow of power to the different components of the This module (410) ensures that each component receives the optimal amount of power, preventing overloading and reducing the risk of system failure.

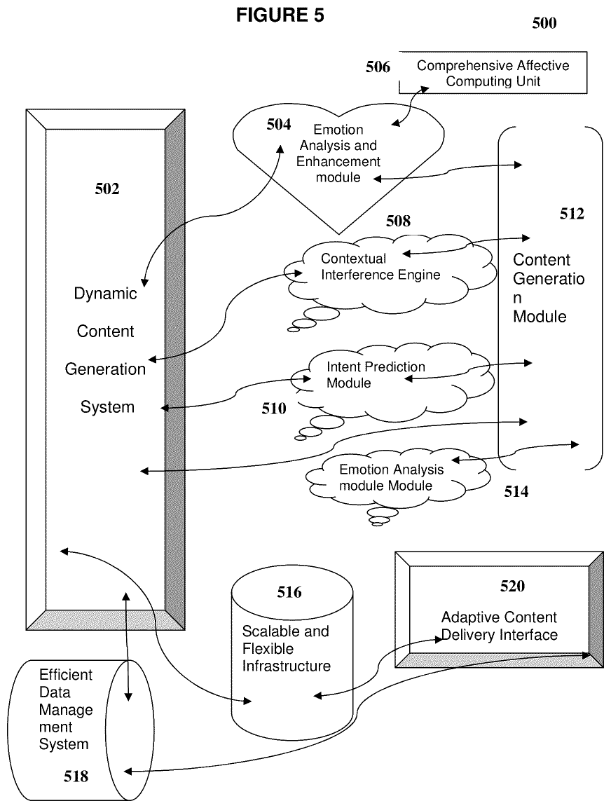

FIG. 5 illustrates how The Dynamic Content Generation System (502) works and consists of several interconnected elements, including:

The Emotion Analysis and Enhancement Module (504) utilizes the affective computing module's (506) deep learning frameworks to execute sentiment analysis and emotional state determination. It analyzes user data, including biometric information, and refines the emotional state classification to ensure accurate content customization.

Contextual Inference Engine (508) applies machine learning-based context inference algorithms to analyze user behaviors. It systematically categorizes user inputs into refined classifications of contextual scenarios, with adaptive updates that reflect changes in user behavior patterns and preferences.

Intent Prediction Module (510) employs iterative neural network models and reinforcement learning techniques to intricately analyze user interactions and predict intended outcomes. By interfacing with the contextual inference engine (508) and the affective computing unit (506), the Intent Prediction Module (510) enhances processing efficiency and reduces latency.

Dynamic Content Generation and Customization Module (512) is responsible for generating and customizing content aligned with identified emotional states, contextual cues, and predicted user intents. It interfaces with the Emotion Analysis and Enhancement Module (514), Contextual Inference Engine (508), and Intent Prediction Module (510) to ensure accurate and relevant content creation.

Scalable and Flexible Infrastructure (516) supports efficient data management and ensures fast, reliable, and personalized content distribution to users. It interfaces with the Adaptive Content Delivery Interface (520) to optimize content delivery.

Efficient Data Management System (518) manages the efficient storage, retrieval, and processing of user data, ensuring seamless content customization and delivery.

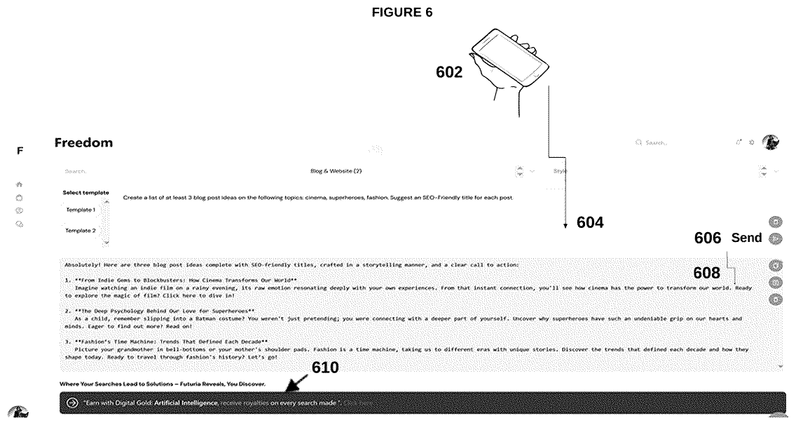

FIG. 6 depicts a representation of the adaptive content delivery interface. User input (604) is facilitated through the sensor-augmented apparatus (602). In this scenario, text input from the user is transmitted to an AI system (606). The AI processes the input and generates an interaction (608). Below the interaction, relevant content is displayed (610), enhancing the user experience.

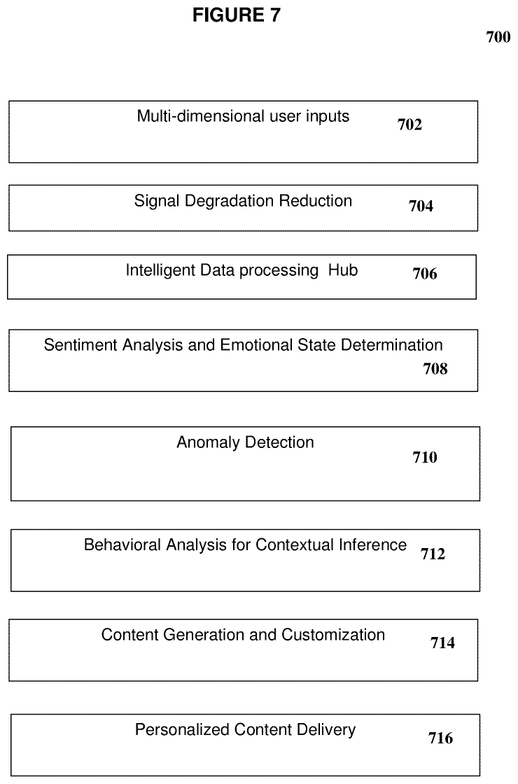

FIG. 7 illustrates a method for enhanced data processing and artificial intelligence query resolution with personalized content delivery. The method is utilizing at least one Ai driven computing device (701). The process begins with receiving multi-dimensional user inputs (702) through a sensor-augmented apparatus. The user inputs undergo signal degradation reduction (704) using data fusion and machine learning techniques. The refined user data is then processed and further refined (103) in an intelligent assimilation hub.

Subsequently, sentiment analysis and emotional state determination (104) are conducted using deep learning frameworks. Security is ensured by detecting anomalies (705) via predictive modeling. User behaviors are analyzed (706) for contextual inference using machine learning techniques.

User intents are predicted (708) through neural networks and reinforcement learning models (710). Based on contextual and emotional data, content is generated and customized (712). Finally, personalized content is delivered through an adaptive interface (714).

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A system for enhanced data processing and artificial intelligence (AI) query resolution with personalized content delivery, comprising:
one or more AI-driven edge computing device selected from the group consisting of AI-optimized GPUs, AI-enhanced FPGAs, AI-integrated network interfaces, AI-controlled motor drivers, AI-assisted data storage devices, AI-powered audio processors, AI-driven thermal management systems, AI-enhanced display controllers, AI-managed battery systems, AI-enabled robotic controllers, AI-driven wearable computing components;
a sensor-augmented input apparatus, comprising a plurality of sensors and a data fusion module with AI-driven algorithms for processing inputs;
an intelligent data processing hub, communicatively coupled to a sensor-augmented input apparatus, comprising an AI power management module, wherein the intelligent data processing hub comprises one or more of the following high-performance materials for specific functions: Graphene; Carbon Nanotubes; Topological Insulators; Metamaterials; Indium Phosphide (InP); Gallium Nitride (GaN); Stanene; Bismuth Ferrite (BiFeO3); Nanostructured Silicon (NSi); Graphene Oxide (GO);
an affective computing module, communicatively coupled to the intelligent data processing hub, incorporating sentiment analysis and anomaly detection;
a contextual inference engine, communicatively linked to the intelligent data processing hub, comprising a behavior analysis module and an adaptive update module;
a predictive intent recognition system, communicatively coupled to both the contextual inference engine and the affective computing module, equipped with an interaction analysis module;
a dynamic content generation system, communicatively connected to the affective computing module, contextual inference engine, and predictive intent recognition system, and a data management module for tailoring information; and
an adaptive delivery interface, communicatively coupled to the personalized generation system.

2. The system of claim 1, wherein the sensor-augmented input apparatus comprises a plurality of sensors for receiving multi-dimensional inputs specifically including, but not limited to: textual data, vocal commands, gestural interactions, biometric parameters, ambient light conditions, sound waves, geolocation information, brain-computer interfaces, haptic interfaces, quantum sensors, synthetic biology sensors adapted to detect biochemical changes in an environment, a molecular communication interface, facilitating interaction with nano-scale devices, as well as olfactory and gustatory interfaces.

3. The system of claim 1, further comprises a self-diagnosing and self-repairing module with AI-driven predictive maintenance, capable of diagnosing potential failures, suggesting solutions, and autonomously performing minor repairs using self-healing materials.

4. The system of claim 1, further comprising a feedback mechanism that utilizes machine learning algorithms for real-time interaction adjustments and continuous improvement of sentiment analysis and emotional state determination.

5. The system of claim 1, wherein the intelligent data processing hub comprises an AI-powered encryption module that ensures end-to-end data security, incorporating blockchain technology.

6. The system of claim 1, wherein the intelligent data processing hub uses self-healing nanomaterials and adaptive thermal management systems for increased lifespan and reliability.

7. The system of claim 1, wherein the intelligent data processing hub includes a multilingual data preprocessing unit with automatic language detection and translation capabilities.

8. The system of claim 1, wherein the intelligent data processing hub includes an AI-driven space-time compression algorithm for data storage.

9. The system of claim 1, wherein the intelligent data processing hub comprises:
a quantum communication interface, including an entangled photon system for secure and instantaneous data exchange and a decryption module for safeguarded transmission, facilitating encrypted, high-speed data transfer; and
a high-speed data processing module utilizing photonic computing technology, consisting of a photon-based arithmetic logic unit (ALU), a photonic memory, and an interface for communication with the intelligent data processing hub.

10. The system of claim 1, wherein the adaptive content generation system employs a deep-learning neural network to create personalized content in real-time, responsive to individual user preferences and behavior patterns.

11. The system of claim 1, wherein the adaptive delivery interface comprises a holographic generation subsystem for immersive, multi-sensory personalized experiences.

12. The system of claim 1, the adaptive delivery interface is integrated with various systems, including, but not limited to: smartphones, smart watches, desktop PCs, laptops, tablets, smart TV systems, IoT-enabled water devices, smart home assistants, fitness trackers, smart appliances, autonomous vehicles, drones, augmented reality (AR) and virtual reality (VR) headsets, wearable biometric sensors, and future artificial intelligence (AI) devices, such as intelligent personal assistants, AI-powered home automation systems, and AI-enabled robotics.

13. A method for enhanced data processing and artificial intelligence query resolution with personalized delivery, comprising:
a. utilizing at least one AI-driven edge computing device selected from the group consisting of AI-optimized GPUs, AI-enhanced FPGAs, AI-integrated network interfaces, AI-controlled motor drivers, AI-assisted data storage devices, AI-powered audio processors, AI-driven thermal management systems, AI-enhanced display controllers, AI-managed battery systems, AI-enabled robotic controllers, AI-driven wearable computing components;
b. receiving and processing multi-modal inputs using a sensor-equipped input apparatus and AI-driven data fusion;
c. communicatively coupling an intelligent data processing hub to the sensor-augmented input apparatus, wherein the intelligent data processing hub comprises one or of the following high-performance materials for specific functions: Graphene; Carbon Nanotubes; Topological Insulators; Metamaterials; Indium Phosphide (InP); Gallium Nitride (GaN); Stanene; Bismuth Ferrite (BiFeO3); Nanostructured Silicon (NSi); Graphene Oxide (GO).
d. incorporating an affective computing module, identifying and interpreting emotional states via sentiment analysis, and enhancing system security through anomaly detection;
e. communicatively linking a contextual inference engine, dissecting behaviors and categorizing inputs into contextual scenarios via behavior analysis, and dynamically adjusting to reflect behavior pattern changes via adaptive update;
f. communicatively coupling a predictive intent recognition system, examining interactions to forecast intended outcomes via interaction analysis; and
g. communicatively coupling with a dynamic content generation system producing and tailoring information in alignment with identified emotional states, contextual cues, and predicted intents via generation and data management modules.

14. The method of claim 13, further comprising a feedback mechanism that utilizes machine learning algorithms for real-time interaction adjustments and continuous improvement of sentiment analysis and emotional state determination.

15. The method of claim 13, further comprising an AI-powered encryption module that ensures end-to-end data security, incorporating blockchain technology.

16. The method of claim 13, wherein the intelligent data processing hub uses an AI-driven space-time compression algorithm for data storage.

17. The method of claim 13, further comprising a quantum communication interface to transmit data between a data processing hub and a remote device.

18. The method of claim 13, wherein the dynamic content generation system employs a deep-learning neural network to create personalized content in real-time, responsive to individual user preferences and behavior patterns.

19. The method of claim 13, wherein the adaptive delivery interface uses a holographic generation subsystem to generate holographic representations of data.

20. A processor comprising:
a sensor or input interface for obtaining input data from a device, the interface supporting AI-driven data acquisition and equipped with multiple sensors for receiving multi-dimensional inputs, including but not limited to: textual data, vocal commands, gestural interactions, biometric parameters, ambient light conditions, sound waves, geolocation information, brain-computer interfaces, haptic interfaces, quantum sensors, synthetic biology sensors, a molecular communication interface, as well as olfactory and gustatory interfaces;
a data management system including a machine learning module for processing and storing the input data, and optimizing power consumption and reducing heat generation in the processor;
a response generation algorithm utilizing AI for personalized response generation based on the input data, emotional state, contextual cues, and predicted intents;
an affective computing module for identifying user emotional state, employing AI for emotion detection and interpretation and featuring a feedback mechanism utilizing machine learning algorithms for real-time interaction adjustments and continuous sentiment analysis/emotional state improvement;
a contextual inference engine utilizing AI for contextual understanding and pattern recognition based on the input data;
a predictive intent recognition system utilizing AI for predictive modeling and intent recognition based on the input data;
a personalized generation system tailoring information to identified emotional states, contextual cues, and predicted intents based on the input data;
an adaptive delivery interface optimizing fast and reliable distribution of the tailored information based on the input data.
